(19) United States
(12) Patent Application Publication
(10) Pub. No.: US 2020/0325784 A1
(43) Pub. Date: Oct. 15, 2020

(54) Steam Turbine Rotor and Steam Turbine

(71) Applicant: Mitsubishi Hitachi Power Systems, Ltd., Yokohama-shi (JP)

(72) Inventors: Shinji OIKAWA, Yokohama-shi (JP); Takeshi IZUMI, Yokohama-shi (JP); Jun SATO, Yokohama-shi (JP); Kiyoshi SEGAWA, Yokohama-shi (JP); Yuta YANASE, Tokyo (JP)

(21) Appl. No.: 16/833,783

(22) Filed: Mar. 30, 2020

(30) Foreign Application Priority Data
Apr. 11, 2019 (JP) 2019-075409

(51) Int. Cl. F01D 5/30; F01D 5/14

(52) U.S. Cl. CPC F01D 5/30; F05D 2240/30; F01D 5/147

(57) ABSTRACT

According to the present invention, the steam turbine rotor includes an embedded fin which includes: a bent bottom part; and an upright part including a fin tip and a fin root, and which is inserted in a fixing groove and fixed in the fixing groove by means of a locking strip, and has an arrangement wherein a static friction coefficient between a side surface of the fixing groove and a side surface of the fin root, a static friction coefficient between a side surface of the locking strip and a side surface of the fin root, and a static friction coefficient between the side surface of the fixing groove and the side surface of the locking strip are increased.

### CLAIM OF PRIORITY

The present application claims priority from Japanese Patent application serial no. 2019-75409, filed on Apr. 11, 2019, the content of which is hereby incorporated by reference into this application.

### TECHNICAL FIELD

The present invention relates to a steam turbine rotor including an embedded fin as well as to a steam turbine.

### BACKGROUND OF THE INVENTION

The steam turbine is provided with a seal fin in order to prevent leakage of steam (working fluid) from a clearance defined between an inner periphery of a stationary body and an outer periphery of a rotary body (rotor).

As the seal fin disposed on the rotor, in particular, there are two types of a skived fin formed by machining the rotor and an embedded fin fixed in a groove formed in the rotor.

Of these fins, the embedded fin has a replaceable structure. When an edge of the embedded fin is damaged, therefore, the damaged fin can be replaced with a new one which enables the rotor to recover a sealing performance. However, the embedded fin is not integrally formed with the rotor. In a case where the drawing strength of the embedded fin is below a centrifugal force of the rotor, the embedded fin may be scattered. That is, the embedded fin must be enhanced in the drawing strength in order to improve the reliability of the steam turbine.

The background art of the technical field of the invention is set forth in Japanese Patent Application Laid-Open No. 2017-115917 (Patent Literature 1). Patent Literature 1 discloses a seal fin which includes: a bottom part disposed in a fixing groove in a manner to extend in a groove width direction of the fixing groove; and a fin part upstanding from a first end with respect to the groove width direction of the fixing groove toward an opening of the fixing groove so as to control the circulation of the working fluid. The bottom part is formed with a bent portion at a base thereof in a manner that the bent portion protrudes toward the first end, while the bottom part is formed with a first slant plane at the other end thereof in a manner that the first slant plane is directed to the opening of the fixing groove when the bottom part is placed in the fixing groove. The bent portion is locked to a croze in the fixing groove while the first slant plane is locked by a locking piece. According to Patent Literature 1, the structure is adapted to prevent the seal fin from disengaging from the fixing groove.

### SUMMARY OF THE INVENTION

Patent Literature 1 describes that the seal fin is prevented from disengaging from the fixing groove.

However, because of high temperatures of the steam turbine and the large diameter of a rotor shaft, the embedded fin is required of further enhanced drawing strength than before.

In this connection, the present invention provides a steam turbine rotor and a steam turbine which feature an embedded fin having an excellent drawing strength to cope with, for example, further rise in steam temperature, further increase in the diameter of the rotor shaft and the like.

According to an aspect of the present invention for achieving the above object, a steam turbine rotor includes an embedded fin which includes: a bent bottom part; and an upright part including a fin tip and a fin root, and which is inserted in a fixing groove and fixed in the fixing groove by means of a locking strip, and has an arrangement wherein a static friction coefficient between a side surface of the fixing groove and a side surface of the fin root, a static friction coefficient between a side surface of the locking strip and a side surface of the fin root, and a static friction coefficient between the side surface of the fixing groove and the side surface of the locking strip are increased.

A steam turbine according to an aspect of the present invention includes such a steam turbine rotor.

According to the present invention, there is provided a steam turbine rotor and a steam turbine which include an embedded fin having an excellent drawing strength to cope with the further rise in steam temperature, further increase in the diameter of the rotor shaft, and the like.

The foregoing and other objects, components, and advantageous effects of the present invention will become more apparent from the following description of the embodiments thereof.

### BRIEF DESCRIPTION OF THE DRAWINGS

FIG. 1 is a schematic diagram illustrating an embedded fin without a croze according to an embodiment of the present invention.

FIG. 2 is a schematic diagram illustrating an embedded fin including the croze according to the embodiment hereof.

FIG. 3 is a schematic diagram illustrating a steam turbine according to the embodiment hereof.

### DETAILED DESCRIPTION

The embodiments of the present invention will hereinbelow be described with reference to the accompanying drawings, in which like reference numerals refer to the same or similar components. Those components are explained only once in some cases to avoid repetitions.

### First Embodiment

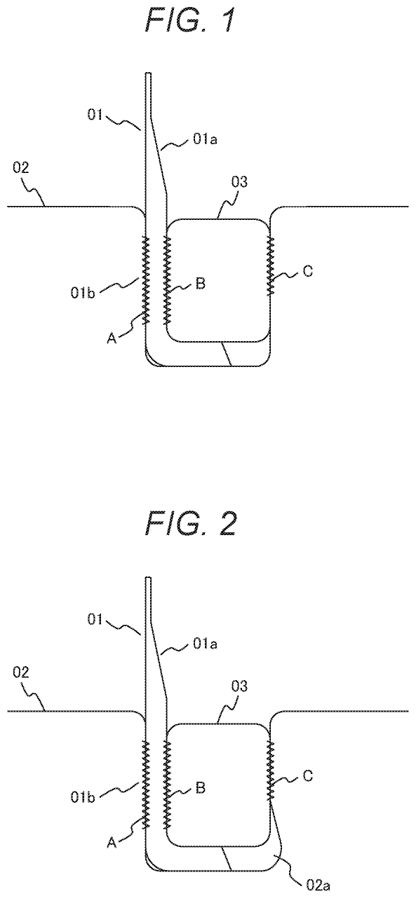

FIG. 1 is a schematic diagram illustrating an embedded fin without a croze described herein, which is shown in section.

A steam turbine is provided with a seal fin in order to prevent the leakage of steam (working fluid) through a clearance formed between an inner periphery (not shown) of a stationary body and a rotary body (steam turbine rotor) (hereinafter, referred to as “rotor”) 02.

As the seal fin disposed on the rotor, in particular, there are two types which include: a skived fin formed by machining the rotor; and an embedded fin fixed in a groove formed in the rotor.

The seal fin described in this embodiment is the embedded fin. Because of a replaceable configuration, an embedded fin 01 can be replaced with a new embedded fin 01 for recovery of sealing performance in a case where an edge of the fin is damaged.

The embedded fin 01 described in the embodiment is formed by longitudinally bending an end of a metal sheet having a thickness on the order of 0.5 to 1.0 mm, longitudinal sides, and transverse sides so as to form an L-shaped workpiece (in section). The L-shaped workpiece in section is longitudinally worked to form an arc-like shape. When the L-shaped workpiece is arcuately bent in the longitudinal direction, the work piece is finally bent into a ring shape by using a radius die conforming to an outer peripheral curved plane of the rotor 02.

The L-shaped structure by L-bending can be formed by bending a plate material or by spinning. A method of forming a workpiece by skiving a raw material is also applicable to form the L-shaped structure.

In order to be assembled to the rotor 02, this embedded fin 01 has a ring structure which is segmented in a circumferential direction of the rotor 02. It is preferred that the ring structure is equally divided into two to four segments. This is because the smaller the number of gaps between the embedded fin segment 01 and the embedded fin segment 01, the greater is the effect to prevent the steam leakage. The embedded fin 01 is also improved in processability by dividing the ring structure into equal segments.

The embedded fins 01 are axially mounted to the rotor 02 in multiple tiers (e.g., 2 to 10 tiers). Thus, the steam is prevented from leaking through clearance between a rotor blade (rotary body) and a stator vane (stationary body).

The embedded fin 01 according to the embodiment includes a bent bottom part and an upright part (part extended in an outer circumferential direction), having the L-shape as seen in section.

From a viewpoint of enhanced sealing performance, the embedded fin 01 according to the embodiment has a structure where a fin tip 01a has a smaller thickness than that of a fin root 01b, as seen in section. A thin portion of the fin tip 01a can be formed by rolling press or skiving.

As just described, the upright part of the embedded fin 01 has the fin tip 01a and the fin root 01b.

After assembled to the rotor 02, the embedded fin 01 is processed by a lathe turning machine or the like such that the fin has a predetermined outside diameter at the edge thereof. For this reason, the embedded fin 01 is formed with an excess thickness at the edge thereof. The cross-section of the embedded fin 01 may also have an I-shape, U-shape, or the like, other than the L-shape.

On the other hand, a fixing groove 04 for fixing the embedded fin therein is formed in an outer periphery of the rotor 02 along the whole circumference thereof. It is preferred for this fixing groove 04 to have a ratio of width (axial width of the rotor 02) to depth in the rage between 1:2 or more and 1:4 or less. This configuration ensures an excellent drawing strength of the fin.

The fin tip 01a of the embedded fin 01 is a portion longer than a depth of the fixing groove 04. The fin root 01b of the embedded fin 01 is a portion shorter than the depth of the fixing groove 04. It is preferred that the bottom part of the embedded fin 01 is shorter than the width of the fixing groove 04.

The embedded fin 01 is fixed in the fixing groove 04 by inserting the fin root 01b of the embedded fin 01 into the fixing groove 04, and inserting a locking strip 03 from above the embedded fin 01 (from an outer peripheral side of the fin) followed by press-fitting the locking strip 03 in the groove. The press-fitting of the locking strip 03 is continued till the locking strip 03 is lowered from a surface of the rotor 02 by a predetermined range of subduction amount.

A press-fitting method is exemplified by the use of air hammer or roller. However, any method that can achieve sufficient plastic deformation of the locking strip 03 is usable.

While a material of the embedded fin 01 and the locking strip 03 varies depending upon the use environment, it is a general practice to use carbon steel or stainless steel.

In the rotor 02 according to the embodiment, the embedded fin 01, which includes the bent bottom part, and the upright part including the fin tip 01a and the fin root 01b, is inserted in the fixing groove 04 and fixed in the fixing groove 04 by means of the locking strip 03.

The drawing strength of the embedded fin 01 significantly depends upon static frictional forces between respective pairs of the embedded fin 01 and the locking strip 03, the embedded fin and the rotor 02 formed with the fixing groove 04, and the locking strip 03 and the rotor, which are in contacting relation with one another.

According to the embodiment, in particular, a static friction coefficient (A) between a side surface of the fixing groove 04 and a side surface of the fin root 01b (outside surface of the upright part); a static friction coefficient (B) between a side surface of the locking strip 03 and a side surface of the fin root 01b (inside surface of the upright part); and a static friction coefficient (C) between the side surface of the fixing groove 04 and the side surface of the locking strip 03 are increased. The embedded fin 01 is increased in the drawing strength in this manner.

A method of increasing the static friction coefficient is, for example, a blast treatment. The side surface of the fin root 01b, the side surface of the fixing groove 04 and the side surface of the locking strip 03 can be roughened by injecting a hard material such as steel shot, glass beads or sand to such surfaces so that the static friction coefficients thereof can be increased. Another method of increasing the static friction coefficient is, for example, knurling.

The blast treatment on the side surface of the fin root 01b may be performed at any time. However, if the surface roughness is increased at any part (e.g., the fin tip 01a) other than the fin root 01b, it could result in the decrease in fatigue strength or sealing performance at such parts. Therefore, these parts are masked before the blast treatment is performed.

Similarly, the blast treatment is also performed on the side surface of the locking strip 03 so that the locking strip 03 is increased in the static friction coefficient at its contact parts with the side surface of the fin root 01b and the side surface of the fixing groove 04. Thus, the embedded fin 01 is increased in the drawing strength.

As compared with a case where the surfaces are not roughed (e.g., a static friction coefficient at contact area between the side surface of the fin root 01b and the side surface of the fixing groove 04: 0.4 to 0.5), the embodiment can increase the static friction coefficient to 0.5 or more, thus enhancing the drawing strength of the embedded fin 01.

Out of these static friction coefficients A, B, C in particular, it is preferred to maximize the coefficient A. This leads to an even greater improvement in the drawing strength of the embedded fin 01.

According to the embodiment, the side surface of the fin root 01b (outer side of the upright part) has greater surface roughness than the side surface of the fixing groove 04. Further, the side surface of the locking strip 03 has greater surface roughness than the side surface of the fixing groove 04. Thus, the drawing strength of the embedded fin 01 can be improved even further.

The embodiment can provide a steam turbine rotor including the (highly strengthened) embedded fin having an excellent drawing strength to cope with further rise in steam temperature, further increase in the diameter of the rotor shaft, and the like. The embodiment is adapted to enhance the reliability of the steam turbine employing such a steam turbine rotor.

### Second Embodiment

FIG. 2 is a schematic diagram illustrating an embedded fin with a croze described herein, which is shown in section.

This embodiment differs from the first embodiment in that the fixing groove 04 has a croze 02a. Specifically, a rotor 02 according to the embodiment differs from that of the first embodiment in that the fixing groove 04 has the croze 02a.

As described, the embodiment includes the croze 02a in the fixing groove 04 such that the locking strip 03 gets into this croze 02a, thus further enhancing the drawing strength of the embedded fin 01.

### Third Embodiment

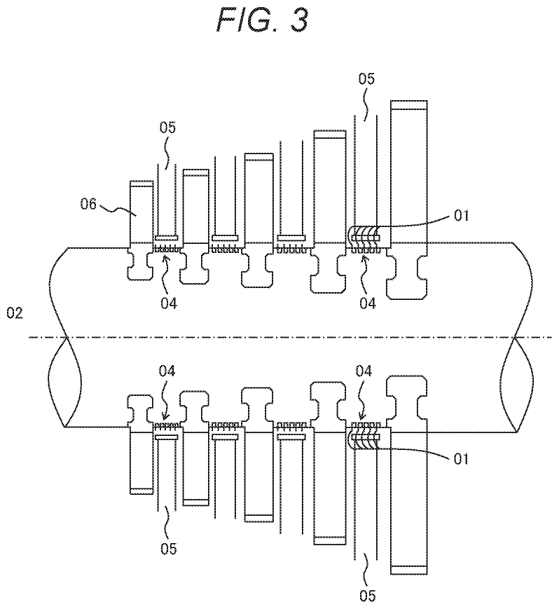

FIG. 3 is a schematic diagram illustrating a steam turbine according to an embodiment hereof.

A steam turbine according to this embodiment includes: the rotor 02; a rotor blade 06 mounted to the rotor 02; a stator vane 05; and an embedded seal fin part 04.

The stator vane 05 operates to produce kinetic momentum in a rotational direction by imparting a velocity energy to steam by expanding the steam while changing the direction of the steam flow.

The embedded seal fin part 04 is provided with an embedded seal fin 01. The embedded seal fin 01 is so assembled as to inhibit the leakage of steam from clearance between an edge of the stator vane 05 and the rotor 02.

The rotor blade 06 is mounted to the rotor 02 and operates to convert a thermal energy of the steam into a rotational energy of the rotor 02.

The embodiment can provide a steam turbine enhanced in reliability by mounting the embedded fin 01 according to the first or second embodiment to such a rotor 02 of the steam turbine. Namely, the steam turbine according to this embodiment includes the rotor 02 according to the first or the second embodiment hereof.

The above-described invention is not limited to the foregoing embodiments but can include a variety of modifications. For instance, the foregoing embodiments are detailed description of the present invention for clarity but the present invention is not necessarily limited to those including all the components described.

### LIST OF REFERENCE SIGNS

01 embedded fin
01a fin tip
01b fin root
02 rotor
02a croze
03 locking strip
04 embedded seal fin
05 stator vane
06 rotor blade

What is claimed is:

1. A steam turbine rotor comprising an embedded fin which includes: a bent bottom part; and an upright part including a fin tip and a fin root, and which is inserted in a fixing groove and fixed in the fixing groove by means of a locking strip,
wherein a static friction coefficient between a side surface of the fixing groove and a side surface of the fin root, a static friction coefficient between a side surface of the locking strip and a side surface of the fin root, and a static friction coefficient between the side surface of the fixing groove and the side surface of the locking strip are increased.

2. The steam turbine rotor according to claim 1, wherein, of the static friction coefficient between the side surface of the fixing groove and the side surface of the fin root, the static friction coefficient between the side surface of the locking strip and the side surface of the fin root, and the static friction coefficient between the side surface of the fixing groove and the side surface of the locking strip, the static friction coefficient between the side surface of the fixing groove and the side surface of the fin root is the largest.

3. The steam turbine rotor according to claim 2, wherein the fixing groove has a width-to-depth ratio of 1:2 or more and 1:4 or less.

4. The steam turbine rotor according to claim 1, wherein the side surface of the fin root has a larger surface roughness than the side surface of the fixing groove.

5. The steam turbine rotor according to claim 1, wherein the side surface of the locking strip has a larger surface roughness than the side surface of the fixing groove.

6. The steam turbine rotor according to claim 1, wherein the fixing groove includes a croze.

7. A steam turbine comprising the steam turbine rotor according to claim 1.
